(19) United States
(12) Patent Application Publication
(10) Pub. No.: US 2023/0305312 A1
(43) Pub. Date: Sep. 28, 2023

(54) IMAGE DISPLAY DEVICE AND ILLUMINATION DEVICE

(71) Applicant: Panasonic Intellectual Property Management Co., Ltd., Osaka (JP)

(72) Inventors: Tatsuo ITOH, Osaka (JP); Akira KUROZUKA, Osaka (JP)

(73) Assignee: Panasonic Intellectual Property Management Co., Ltd., Osaka (JP)

(21) Appl. No.: 18/200,934

(22) Filed: May 23, 2023

Related U.S. Application Data
(63) Continuation of application No. PCT/JP2021/041635, filed on Nov. 11, 2021.

(30) Foreign Application Priority Data
Nov. 25, 2020 (JP) 2020-195129

(51) Int. Cl. G02B 27/48; G02F 1/1335; G02F 1/13357

(52) U.S. Cl. CPC G02B 27/48; G02F 1/133607; G02F 1/133611; G02B 3/005

(57) ABSTRACT

An image display device includes: a laser light source; a first lens that converges a laser beam emitted from the laser light source, in a first direction; a second lens that converges the laser beam emitted from the laser light source, in a second direction perpendicular to the first direction; a spatial light modulator irradiated with the laser beam that has passed through the first lens and the second lens; a first vibrator that vibrates the first lens along a first vibration plane; and a second vibrator that vibrates the second lens along a second vibration plane non-parallel to the first vibration plane.

### CROSS REFERENCE TO RELATED APPLICATION

This application is a continuation of International Application No. PCT/JP2021/041635 filed on Nov. 11, 2021, entitled “IMAGE DISPLAY DEVICE AND ILLUMINATION DEVICE”, which claims priority under 35 U.S.C. Section 119 of Japanese Patent Application No. 2020-195129 filed on Nov. 25, 2020, entitled “IMAGE DISPLAY DEVICE AND ILLUMINATION DEVICE”. The disclosures of the above applications are incorporated herein by reference.

### BACKGROUND OF THE INVENTION

### Field of the Invention

The present invention relates to an image display device that irradiates a spatial light modulator with light to display an image, and an illumination device suitable for use in the image display device.

### Description of Related Art

To date, image display devices that irradiate a spatial light modulator with light to display an image have been commercialized. In this type of image display device, a laser light source can be used as a light source in addition to a mercury lamp.

By using the laser light source as the light source, a high luminance can be achieved. In addition, compared to the mercury lamp, the laser light source can reduce power consumption and can dramatically increase the life of the light source. Furthermore, compared to the mercury lamp, the laser light source has a shorter startup time, and allows an image to be displayed at substantially 100% brightness immediately after the startup of the image display device. In addition, the laser light source can generate less heat than the mercury lamp, so that a mechanism such as a cooling fan can be omitted, and the size of the image display device can be reduced.

However, the laser light source has high light coherence, so that random intensity patterns (speckles) are likely to be superimposed on a display image. Therefore, in the case where the laser light source is used as the light source of the image display device, it is necessary to suppress speckles superimposed on a display image.

Japanese Patent No. 4175078 describes an image display device having a configuration for suppressing speckles superimposed on a display image. In this configuration, a beam shaping element that changes the intensity distribution of coherent light to distribute the light with a predetermined intensity distribution and emit the light, is micro-vibrated in a direction perpendicular to the optical axis of an optical system. Accordingly, speckles are averaged by human eyes, so that the speckles become less noticeable on a display image.

However, in the above method, if images of speckles that periodically change due to micro-vibration correlate with each other, the speckles are less likely to be averaged by human eyes, so that the speckles may remain on a display image.

### SUMMARY OF THE INVENTION

A first aspect of the present invention is directed to an image display device. The image display device according to this aspect includes: a laser light source; a first lens that converges a laser beam emitted from the laser light source, in a first direction; a second lens that converges the laser beam emitted from the laser light source, in a second direction perpendicular to the first direction; a spatial light modulator irradiated with the laser beam that has passed through the first lens and the second lens; a first vibrator that vibrates the first lens along a first vibration plane; and a second vibrator that vibrates the second lens along a second vibration plane non-parallel to the first vibration plane.

In the image display device according to this aspect, since the first lens and the second lens are vibrated along the first vibration plane and the second vibration plane non-parallel to each other, speckles that change due to the vibration of the first lens and the second lens are less likely to correlate with each other. Therefore, the speckles that change along with the vibration are more likely to be averaged by human eyes, so that the speckles become even less noticeable. Accordingly, speckles superimposed on a display image can be suppressed more effectively.

A second aspect of the present invention is directed to an illumination device. The illumination device according to this aspect includes: a laser light source; a first lens that converges a laser beam emitted from the laser light source, in a first direction; a second lens that converges the laser beam emitted from the laser light source, in a second direction perpendicular to the first direction; a first vibrator that vibrates the first lens along a first vibration plane; and a second vibrator that vibrates the second lens along a second vibration plane non-parallel to the first vibration plane.

In the illumination device according to this aspect, as in the first aspect, since the first lens and the second lens are vibrated along the first vibration plane and the second vibration plane non-parallel to each other, images of speckles that change due to the vibration of the first lens and the second lens are less likely to correlate with each other. Therefore, speckles in the illumination region can be suppressed more effectively.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1A is a side view showing an optical system of an image display device according to an embodiment;

FIG. 1B is a plan view showing the optical system of the image display device according to the embodiment;

FIG. 2A is a perspective view showing the configuration of a first lens according to the embodiment;

FIG. 2B is a perspective view showing the configuration of a second lens according to the embodiment;

FIG. 3A and FIG. 3B respectively illustrate methods for disposing the first lens and the second lens and methods for setting a first vibration plane and a second vibration plane according to the embodiment;

FIG. 4A is a perspective view showing a first movement plane on which first focal lines move due to vibration of the first lens according to the embodiment;

FIG. 4B is a perspective view showing a second movement plane on which second focal lines move due to vibration of the second lens according to the embodiment;

FIG. 4C is a perspective view showing a state where the first movement plane and the second movement plane according to the embodiment are integrated;

FIG. 5 is a block diagram showing the configuration of a circuit system of the image display device according to the embodiment;

FIG. 6A to FIG. 6F are each a diagram schematically showing a movement trajectory of a secondary light source when a first frequency and a second frequency according to the embodiment are varied;

FIG. 7A and FIG. 7B respectively illustrate methods for disposing a first lens and a second lens and methods for setting a first vibration plane and a second vibration plane according to Modification 1;

FIG. 8A is a perspective view showing a first movement plane on which first focal lines move due to vibration of the first lens according to Modification 1;

FIG. 8B is a perspective view showing a second movement plane on which second focal lines move due to vibration of the second lens according to Modification 1;

FIG. 8C is a perspective view showing a state where the first movement plane and the second movement plane according to Modification 1 are integrated; and

FIG. 9A and FIG. 9B respectively illustrate methods for disposing a first lens and a second lens and methods for setting a first vibration plane and a second vibration plane according to Modification 2.

It should be noted that the drawings are solely for description and do not limit the scope of the present invention by any degree.

### DETAILED DESCRIPTION

Hereinafter, an embodiment of the present invention will be described with reference to the drawings. For convenience, in each drawing, X, Y, and Z axes that are orthogonal to each other are additionally shown. The Z-axis positive direction is a projection direction of light (video light) modulated by a spatial light modulator.

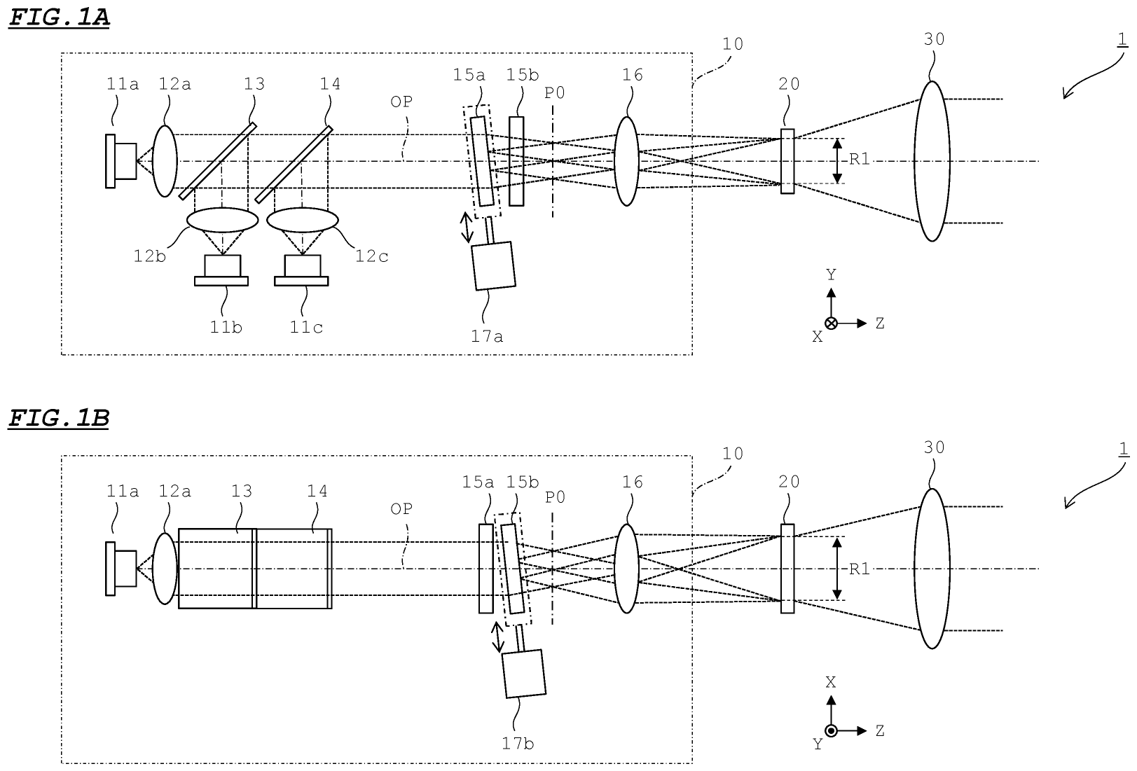

FIG. 1A is a side view showing an optical system of an image display device 1, and FIG. 1B is a plan view showing the optical system of the image display device 1.

As shown in FIG. 1A and FIG. 1B, the image display device 1 includes an illumination device 10, a spatial light modulator 20, and a projection lens 30. The illumination device 10 irradiates the entirety of a light modulation region R1 of the spatial light modulator 20 with illumination light. Here, the illumination light is light obtained by integrating laser beams in red, green, and blue wavelength bands. The light modulation region R1 has a rectangular contour having two short sides parallel to the Y axis and two long sides parallel to the X axis. The light modulation region R1 corresponds to an illumination region of the illumination device 10.

The spatial light modulator 20 modulates the illumination light incident thereon from the illumination device 10, according to a video signal, and generates a projection image. The spatial light modulator 20 is, for example, a liquid crystal panel capable of generating a color image. The spatial light modulator 20 modulates the laser beams in the red, green, and blue wavelength bands incident thereon from the illumination device 10, for each pixel according to a video signal, and generates a projection image.

In the configuration of FIG. 1A and FIG. 1B, a transmission-type spatial light modulator 20 is used, but a reflection-type spatial light modulator may be used. In this case, as the spatial light modulator 20, a micromirror array having a MEMS mirror disposed at each pixel position may be used in addition to a reflection-type liquid crystal panel.

The projection lens 30 projects video light generated by the spatial light modulator 20, onto a projection region to display an image on the projection region. The projection lens 30 may not necessarily be composed of a single lens, and may be composed of a combination of multiple lenses. Also, instead of the projection lens 30, a mirror having a concave-shaped reflection surface may be used, or a projection optical system composed of a combination of a lens and a mirror may be used.

The illumination device 10 includes laser light sources 11a to 11c, collimator lenses 12a to 12c, dichroic mirrors 13 and 14, a first lens 15a, a second lens 15b, a field lens 16, a first vibrator 17a, and a second vibrator 17b.

The laser light source 11a emits a laser beam in the red wavelength band, in the Z-axis positive direction. The laser light source 11b emits a laser beam in the green wavelength band, in the Y-axis positive direction. The laser light source 11c emits a laser beam in the blue wavelength band, in the Y-axis positive direction. The laser light sources 11a to 11c are, for example, semiconductor lasers. Instead of the laser light source 11a, a light source unit that has a plurality of laser light sources 11a, a plurality of optical fibers on which laser beams emitted from the plurality of laser light sources 11a are incident, respectively, and a bundle binding the emission ends of these optical fibers, may be used. Each of the laser light sources 11b and 11c may also be replaced with a light source unit having the same configuration.

The collimator lenses 12a to 12c convert the laser beams emitted from the laser light sources 11a to 11c, into collimated beams, respectively. The collimator lenses 12a to 12c may have apertures for shaping the beam shapes of the laser beams of the respective colors into predetermined shapes.

The dichroic mirror 13 transmits the laser beam in the red wavelength band emitted from the laser light source 11a, and reflects the laser beam in the green wavelength band emitted from the laser light source 11b. The dichroic mirror 14 transmits the laser beams in the red wavelength band and the green wavelength band emitted from the laser light sources 11a and 11b, respectively, and reflects the laser beam in the blue wavelength band emitted from the laser light source 11c.

The laser light sources 11a to 11c and the collimator lenses 12a to 12c are disposed such that the optical axes of the laser beams of the respective colors that have passed through the dichroic mirrors 13 and 14 are aligned with each other. That is, at a stage subsequent to the dichroic mirror 14, the optical axes of the laser light sources 11a to 11c are integrated into a single optical axis OP. The integrated optical axis OP is parallel to the Z axis.

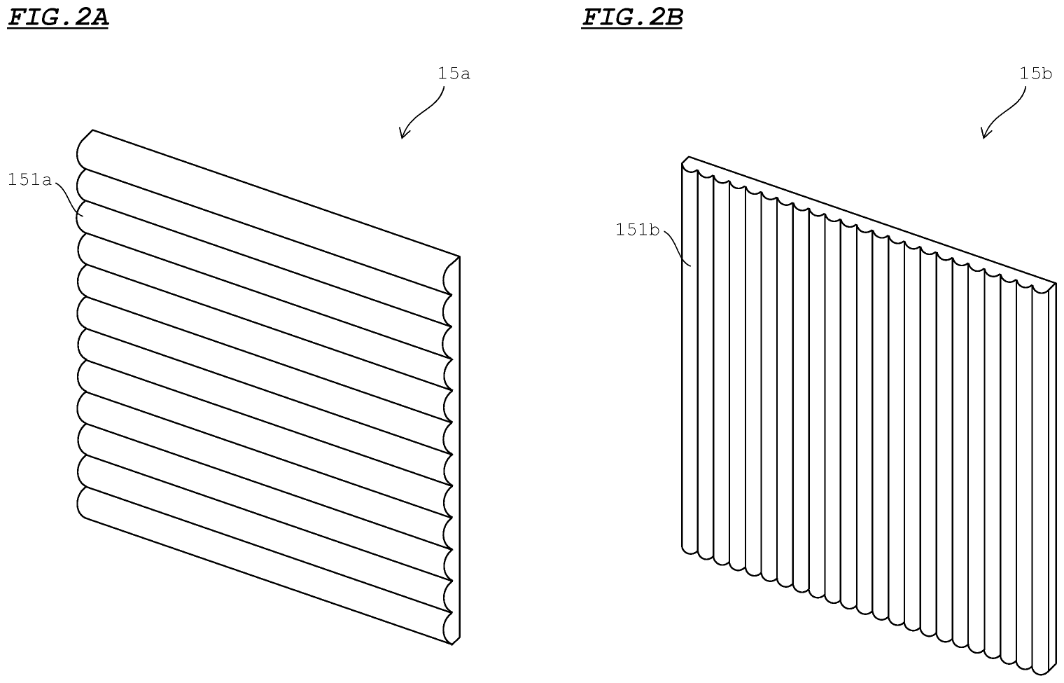

FIG. 2A is a perspective view showing the configuration of the first lens 15a, and FIG. 2B is a perspective view showing the configuration of the second lens 15b.

As shown in FIG. 2A, the first lens 15a includes a plurality of first cylindrical lens portions 151a having a cylindrical shape, on an incident surface thereof. The plurality of first cylindrical lens portions 151a are integrally formed in the first lens 15a so as to be aligned adjacent to each other in a direction perpendicular to the generatrices of the first cylindrical lens portions 151a. Each first cylindrical lens portion 151a converges the laser beam of each color only in the direction perpendicular to the generatrix thereof, and does not converge the laser beam of each color in a direction parallel to the generatrix thereof. That is, each first cylindrical lens portion 151a has a curvature only in the direction perpendicular to the generatrix thereof.

As shown in FIG. 2B, the second lens 15b includes a plurality of second cylindrical lens portions 151b having a cylindrical shape, on an incident surface thereof. The plurality of second cylindrical lens portions 151b are integrally formed in the second lens 15b so as to be aligned adjacent to each other in a direction perpendicular to the generatrices of the second cylindrical lens portions 151b. Each second cylindrical lens portion 151b converges the laser beam of each color only in the direction perpendicular to the generatrix thereof, and does not converge the laser beam of each color in a direction parallel to the generatrix thereof. That is, each second cylindrical lens portion 151b has a curvature only in the direction perpendicular to the generatrix thereof.

In FIG. 2A, the plurality of first cylindrical lens portions 151a are formed on the incident surface of the first lens 15a, but a plurality of first cylindrical lens portions 151a may be formed on an emission surface of the first lens 15a, or may be formed on each of the incident surface and the emission surface of the first lens 15a. Similarly, in FIG. 2B, the plurality of second cylindrical lens portions 151b are formed on the incident surface of the second lens 15b, but a plurality of second cylindrical lens portions 151b may be formed on an emission surface of the second lens 15b, or may be formed on each of the incident surface and the emission surface of the second lens 15b.

Referring back to FIG. 1A and FIG. 1B, the first lens 15a is disposed such that the generatrices of the plurality of first cylindrical lens portions 151a are parallel to the X axis, and the second lens 15b is disposed such that the generatrices of the plurality of second cylindrical lens portions 151b are parallel to the Y axis. The first lens 15a is disposed so as to be tilted at a predetermined angle in a direction parallel to the Y-Z plane from a state of being perpendicular to the optical axis OP, and the second lens 15b is disposed so as to be tilted at a predetermined angle in a direction parallel to the X-Z plane from a state of being perpendicular to the optical axis OP.

The first lens 15a is disposed such that focal lines formed by the plurality of first cylindrical lens portions 151a are positioned in the vicinity of a reference plane P0 perpendicular to the optical axis OP. In addition, the second lens 15b is disposed such that focal lines formed by the plurality of second cylindrical lens portions 151b are positioned in the vicinity of the reference plane P0.

Therefore, the laser beams that have passed through each of regions where the plurality of first cylindrical lens portions 151a and the plurality of second cylindrical lens portions 151b overlap when viewed in a direction parallel to the optical axis OP, are converged in the vicinity of the reference plane PG. That is, the condensed points, by the first cylindrical lens portions 151a and the second cylindrical lens portions 151b, of the laser beams that have passed through each of the regions are arranged in a matrix on the reference plane PG. These condensed points form secondary light sources on the reference plane PG.

The laser beam of each color spreads from these secondary light sources and is incident on the field lens 16. The field lens 16 applies the laser beam of each color incident thereon from each secondary light source, to the light modulation region R1 of the spatial light modulator 20 such that the laser beam spreads over the entirety of the light modulation region R1. That is, the laser beams from the respective secondary light sources are overlapped on the light modulation region R1 of the spatial light modulator 20 by the field lens 16. Accordingly, even if the beam profiles of the laser beams emitted from the laser light sources 11a to 11c are non-uniform, illumination light (laser beam of each color) having a substantially uniform intensity distribution is applied to the spatial light modulator 20.

Meanwhile, in the case where the laser light sources 11a to 11c are used as light sources of the image display device 1 as described above, since the coherence of the laser beam of each color is high, random intensity patterns (speckles) are likely to be superimposed on a display image. Therefore, in the above configuration, it is preferable to provide a configuration for suppressing speckles superimposed on a display image. In this case, a configuration of micro-vibrating the optical element included in the illumination device 10, in a direction intersecting the optical axis OP, to average speckles can be used. However, in this configuration, if speckles that periodically change due to micro-vibration correlate with each other, the speckles are less likely to be averaged, so that the speckles may remain on a display image.

In order to solve such a problem, in the present embodiment, a configuration for reducing the correlation between speckles to suppress the speckles more is used. Specifically, as shown in FIG. 1A and FIG. 1B, the first vibrator 17a for vibrating the first lens 15a along a first vibration plane and the second vibrator 17b for vibrating the second lens 15b along a second vibration plane non-parallel to the first vibration plane, are disposed.

The first vibrator 17a includes a support mechanism which supports the first lens 15a such that the first lens 15a can vibrate along the first vibration plane, and a drive source which drives the first lens 15a along the first vibration plane at a predetermined frequency. The second vibrator 17b includes a support mechanism which supports the second lens 15b such that the second lens 15b can vibrate along the second vibration plane, and a drive source which drives the second lens 15b along the second vibration plane at a predetermined frequency. As each of the drive sources of the first vibrator 17a and the second vibrator 17b, for example, a piezoelectric element, a voice coil, an ultrasonic motor, or the like can be used.

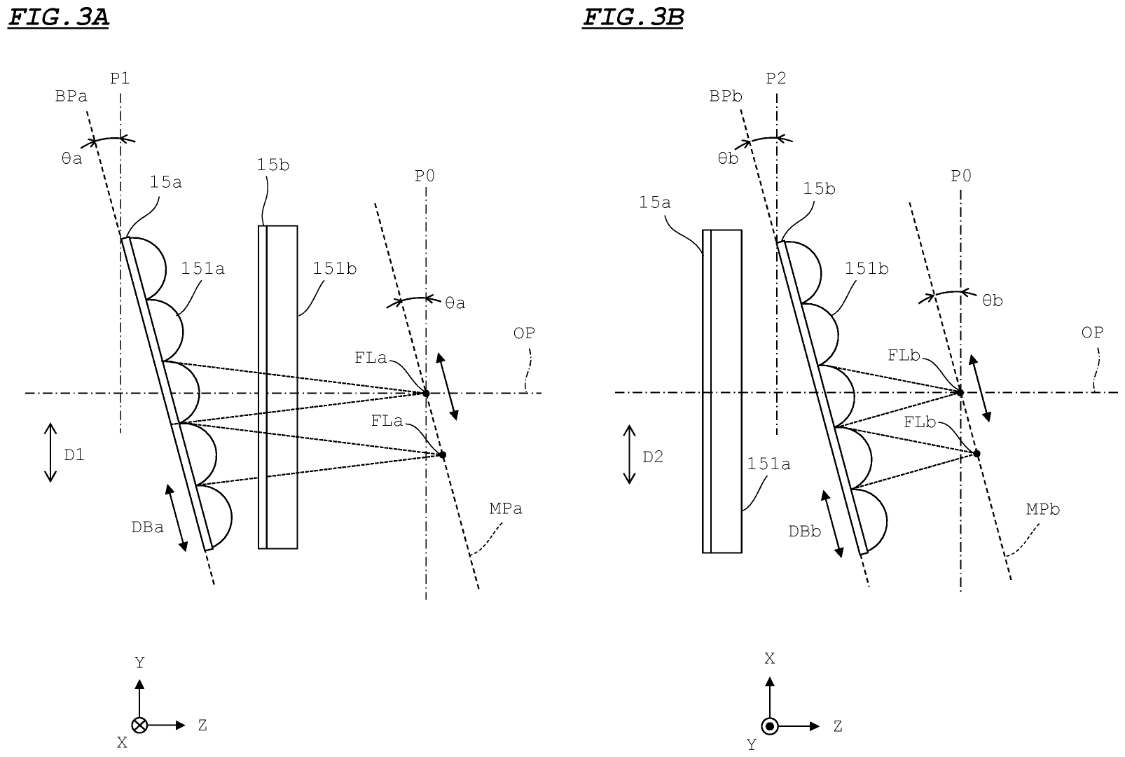

FIG. 3A and FIG. 3B illustrate a method for disposing the first lens 15a and the second lens 15b and a method for setting a first vibration plane BPa and a second vibration plane BPb.

FIG. 3A is a view of an area around the first lens 15a and the second lens 15b as viewed from the X-axis negative side, and FIG. 3B is a view of the area around the first lens 15a and the second lens 15b as viewed from the Y-axis positive side. For convenience, in FIG. 3A and FIG. 3B, the first cylindrical lens portions 151a and the second cylindrical lens portions 151b are formed on the emission surfaces of the first lens 15a and the second lens 15b, respectively, and each of the numbers of first cylindrical lens portions 151a and second cylindrical lens portions 151b are set to five.

As shown in FIG. 3A and FIG. 3B, the first lens 15a and the second lens 15b are disposed such that the generatrices of the first cylindrical lens portions 151a and the generatrices of the second cylindrical lens portions 151b are perpendicular to each other. The generatrices of the first cylindrical lens portions 151a are parallel to the X axis, and the generatrices of the second cylindrical lens portions 151b are parallel to the Y axis.

Each first cylindrical lens portion 151a converges the laser beam of each color in a first direction D1 (Y-axis direction) which is perpendicular to the generatrix of a lens surface of the first cylindrical lens portion 151a and which is perpendicular to the optical axis OP. Each second cylindrical lens portion 151b converges the laser of each color in a second direction D2 (X-axis direction) which is perpendicular to the generatrix of a lens surface of the second cylindrical lens portion 151b and which is perpendicular to the optical axis OP.

The first lens 15a is tilted at a tilt angle θa in the direction parallel to the Y-Z plane, that is, the in-plane direction of a plane perpendicular to the generatrices of the first cylindrical lens portions 151a, from a state of being perpendicular to the optical axis OP. The second lens 15b is tilted at a tilt angle θb in the direction parallel to the X-Z plane, that is, the in-plane direction of a plane perpendicular to the generatrices of the second cylindrical lens portions 151b, from a state of being perpendicular to the optical axis OP.

The first lens 15a is micro-vibrated along the first vibration plane BPa by the first vibrator 17a in FIG. 1A. The first vibration plane BPa is titled at the tilt angle θa with respect to a plane P1 perpendicular to the optical axis OP, in the in-plane direction of a plane (Y-Z plane) perpendicular to the generatrices of the first cylindrical lens portions 151a. The plurality of first cylindrical lens portions 151a are aligned along the first vibration plane BPa. The first lens 15a is micro-vibrated along the first vibration plane BPa in a first vibration direction DBa perpendicular to the generatrices of the first cylindrical lens portions 151a. That is, the first vibrator 17a vibrates the first lens 15a in the first vibration direction DBa which is the direction in which the plurality of first cylindrical lens portions 151a are aligned.

The second lens 15b is micro-vibrated along the second vibration plane BPb by the second vibrator 17b in FIG. 1B. The second vibration plane BPb is tilted at the tilt angle θb with respect to a plane P2 perpendicular to the optical axis OP, in the in-plane direction of a plane (Y-Z plane) perpendicular to the generatrices of the second cylindrical lens portions 151b. The plurality of second cylindrical lens portions 151b are aligned along the second vibration plane BPb. The second lens 15b is micro-vibrated along the second vibration plane BPb in a second vibration direction DBb perpendicular to the generatrices of the second cylindrical lens portions 151b. That is, the second vibrator 17b vibrates the second lens 15b in the second vibration direction DBb which is the direction in which the plurality of second cylindrical lens portions 151b are aligned.

When the first lens 15a and the second lens 15b are at neutral positions before micro-vibration (the mid positions of the ranges of micro-vibration) thereof, first focal lines FLa respectively formed by the plurality of first cylindrical lens portions 151a are positioned on a first movement plane MPa which is tilted at the tilt angle θa from the reference plane P0 in the direction parallel to the Y-Z plane, and second focal lines FLb respectively formed by the plurality of second cylindrical lens portions 151b are positioned on a second movement plane MPb which is tilted at the tilt angle θb from the reference plane P0 in the direction parallel to the X-Z plane. In this case, the secondary light sources formed in a matrix on the reference plane P0 as described above are slightly blurred since the first focal lines FLa and the second focal lines FLb are not on the reference plane P0 except for the secondary light sources on the optical axis OP.

From this state, when the first lens 15a is micro-vibrated in the first vibration direction DBa, the first focal lines FLa formed by the first cylindrical lens portions 151a also vibrate in the first vibration direction DBa along the first movement plane MPa. Due to this vibration, the separation distance from each first focal line FLa to the reference plane P0 changes.

Similarly, when the second lens 15b is micro-vibrated in the second vibration direction DBb, the second focal lines FLb formed by the second cylindrical lens portions 151b also vibrate in the second vibration direction DBb along the second movement plane MPb. Due to this vibration, the separation distance from each second focal line FLb to the reference plane P0 changes.

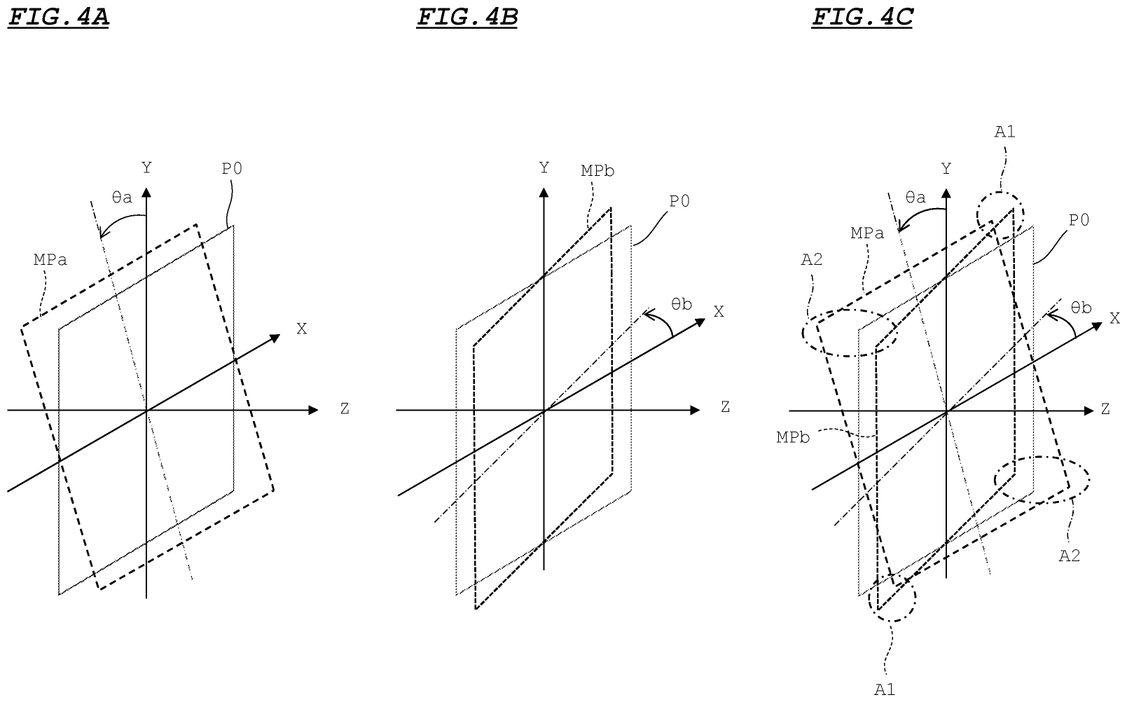

FIG. 4A is a perspective view showing the first movement plane MPa on which the first focal lines FLa move due to the vibration of the first lens 15a, and FIG. 4B is a perspective view showing the second movement plane MPb on which the second focal lines FLb move due to the vibration of the second lens 15b. FIG. 4C is a perspective view showing a state where the first movement plane MPa and the second movement plane MPb are integrated.

As shown in FIG. 4A and FIG. 4B, the first movement plane MPa is tilted at the tilt angle θa with respect to the reference plane P0 in the direction parallel to the Y-Z plane, and the second movement plane MPb is tilted at the tilt angle θb with respect to the reference plane P0 in the direction parallel to the X-Z plane. Accordingly, as shown in FIG. 4C, in regions A1 around opposite corners of the reference plane P0, the distance between the first movement plane MPa and the second movement plane MPb is shorter, but in regions A2 around the other opposite corners of the reference plane P0, the distance between the first movement plane MPa and the second movement plane MPb is increased to be large.

Therefore, when each secondary light source moves due to the vibration of the first lens 15a and the second lens 15b, the distance between the first focal line FLa and the second focal line FLb at the secondary light source changes along with the movement, so that the astigmatic difference of the secondary light source changes. The astigmatic difference refers to the amount of shift in the direction parallel to the optical axis OP between the emission point (origin) of the light spreading in the first direction D1 and the emission point (origin) of the light spreading in the second direction D2.

When the astigmatic difference of each secondary light source changes along with the movement of the secondary light source as described above, speckles that change due to micro-vibration are less likely to correlate with each other. Therefore, compared to the case where both the first lens 15a and the second lens 15b are vibrated perpendicularly to the optical axis OP (the case where the astigmatic difference does not change along with movement), speckles are more likely to be averaged by human eyes, so that the speckles become less noticeable on a display image.

As shown in FIG. 4C, when there are secondary light sources in the regions A1, since the distances between the first focal lines FLa and the second focal lines FLb are short, the astigmatic differences of the secondary light sources are small, and when there are secondary light sources in the regions A2, since the distances between the first focal lines FLa and the second focal lines FLb are long, the astigmatic differences of the secondary light sources are large. Therefore, in the case of vibrating the first lens 15a and the second lens 15b such that the secondary light sources move in a diagonal direction of the reference plane P0, it is preferable to control the vibration of the first lens 15a and the second lens 15b such that the secondary light sources move in the diagonal direction connecting the two regions A2. Accordingly, the change in the astigmatic difference of each secondary light source can be increased, so that the effect of suppressing speckles can be enhanced.

When the secondary light sources move on the reference plane P0 more randomly, the change in the astigmatic difference of each secondary light source becomes more random, so that images of speckles that change due to micro-vibration are less likely to correlate with each other. Therefore, in the vibration control of the first lens 15a and the second lens 15b, it is more preferable to control the vibration of the first lens 15a and the second lens 15b such that the secondary light sources move on the reference plane P0 more randomly.

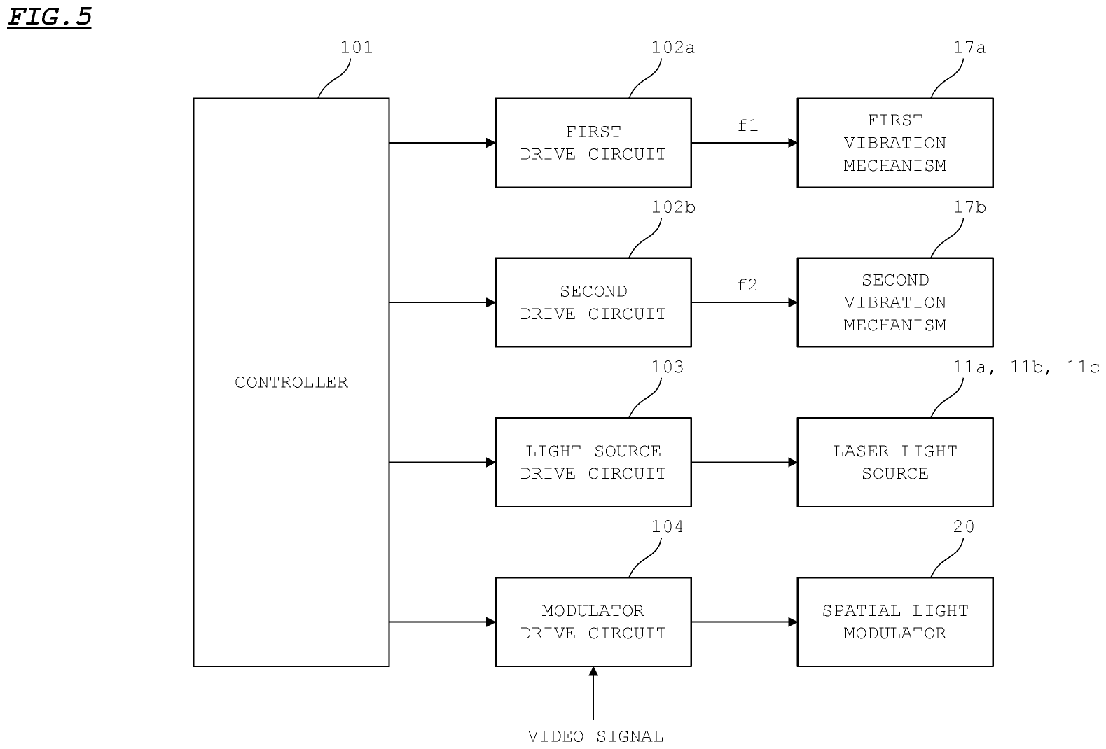

FIG. 5 is a block diagram showing the configuration of a circuit system of the image display device 1.

As shown in FIG. 5, the image display device 1 includes a controller 101, a first drive circuit 102a, a second drive circuit 102b, a light source drive circuit 103, and a modulator drive circuit 104.

The controller 101 includes an arithmetic processing circuit such as a CPU (central processing unit) and a storage medium such as a ROM (read only memory) and a RAM (random access memory), and controls each component according to a program stored in the storage medium. The controller 101 may be composed of a FPGA (field programmable gate array).

The first drive circuit 102a drives the first vibrator 17a according to the control from the controller 101. The second drive circuit 102b drives the second vibrator 17b according to the control from the controller 101. The first drive circuit 102a vibrates the first lens 15a along the first vibration plane BPa at a first frequency f1, and the second drive circuit 102b vibrates the second lens 15b along the second vibration plane BPb at a second frequency f2.

The light source drive circuit 103 drives the laser light sources 11a to 11c according to the control from the controller 101. The modulator drive circuit 104 drives the spatial light modulator 20 according to the control from the controller 101 such that an image based on a video signal is rendered.

The first frequency f1 and the second frequency f2 are preferably set such that the secondary light sources move as randomly as possible due to the vibration of the first lens 15a and the second lens 15b as described above.

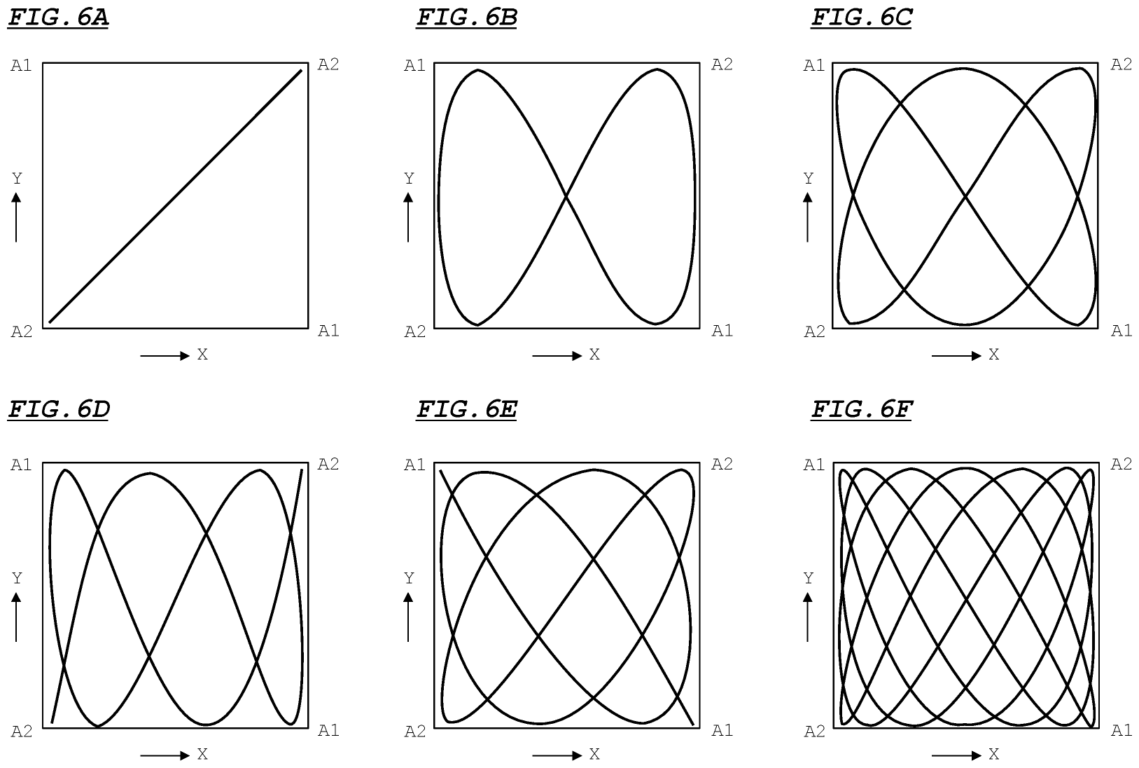

FIG. 6A to FIG. 6F are each a diagram schematically showing a movement trajectory of a secondary light source on the reference plane P0 when the first frequency f1 and the second frequency f2 are varied.

FIG. 6A shows a movement trajectory of the secondary light source when the first frequency f1 and the second frequency f2 are set to be the same and are synchronized. In this case, the secondary light source moves in a straight manner in the diagonal direction. In contrast, when the ratio between the first frequency f1 and the second frequency f2 is changed from 1:1, the movement trajectory of the secondary light source changes as shown in FIG. 6B to FIG. 6F. From FIG. 6B to FIG. 6F, the secondary light source moves more randomly. Here, the movement trajectory in FIG. 6F is the most random. Therefore, to improve the patterns of changes in the astigmatic difference of the secondary light source, it is most preferable to set the ratio between the first frequency f1 and the second frequency f2 such that the movement trajectory in FIG. 6F is realized.

As described above, the first frequency f1 of the first drive circuit 102a and the second frequency f2 of the second drive circuit 102b shown in FIG. 5 are preferably set such that the secondary light sources move on the reference plane P0 as randomly as possible due to the vibration of the first lens 15a and the second lens 15b. Accordingly, the patterns of changes in the astigmatic difference of each secondary light source during the vibration of the first lens 15a and the second lens 15b can be increased, so that the correlation between speckles that change along with the vibration can be reduced. Therefore, speckles generated on a display image can be suppressed more effectively.

Each of the tilt angle θa of the first vibration plane BPa and the tilt angle θb of the second vibration plane BPb shown in FIG. 3A and FIG. 3B is preferably set to be not greater than 26 degrees.

That is, in the case where the first movement plane MPa is tilted at the tilt angle θa (in the case where the first lens 15a is tilted at the tilt angle θa) with respect to the reference plane P0 as shown in FIG. 3A, the vibration amplitude in the Y-axis direction of each secondary light source on the reference plane P0 when the first lens 15a is vibrated is cos θa times the vibration amplitude in the case where the first movement plane MPa is perpendicular to the optical axis OP (in the case where the first lens 15a is not tilted). Also, in the case where the second movement plane MPb is tilted at the tilt angle θb (in the case where the second lens 15b is tilted at the tilt angle θb) with respect to the reference plane P0 as shown in FIG. 3B, the vibration amplitude in the X-axis direction of each secondary light source on the reference plane P0 when the second lens 15b is vibrated is cos θb times the vibration amplitude in the case where the second movement plane MPb is perpendicular to the optical axis OP (in the case where the second lens 15b is not tilted).

In this case, if the tilt angles θa and θb are set to be not greater than 26 degrees, the vibration amplitudes in the Y-axis direction and the X-axis direction of each secondary light source on the reference plane P0 are each not less than 0.9 times that in the case where the first lens 15a is not tilted, and the amount of decrease in vibration amplitude can be reduced to be 10% or less. Accordingly, suppression of speckles by changes in the astigmatic differences of the secondary light sources can be effectively achieved while ensuring large vibration amplitudes of the secondary light sources and maintaining proper averaging of speckles.

### Effects of Embodiment

According to the present embodiment, the following effects are exhibited.

Since, as shown in FIG. 3A and FIG. 3B, the first lens 15a and the second lens 15b are vibrated along the first vibration plane BPa and the second vibration plane BPb which are non-parallel to each other, when the secondary light sources move due to the vibration, the astigmatic differences of the secondary light sources change, whereby speckles that change due to the vibration of the first lens 15a and the second lens 15b are less likely to correlate with each other. Therefore, the speckles that change along with the vibration are more likely to be averaged by human eyes, so that the speckles become even less noticeable. Accordingly, speckles superimposed on a display image can be suppressed more effectively.

As shown in FIG. 3A and FIG. 3B, both the first vibration plane BPa and the second vibration plane BPb are set to be non-perpendicular to the optical axis OP of the laser light sources 11a to 11c. Accordingly, as shown in FIG. 4C, the change in the distance between the first vibration plane BPa and the second vibration plane BPb can be increased, so that the changes in the astigmatic differences of the secondary light sources when the secondary light sources move due to vibration can be larger. Therefore, speckles superimposed on a display image can be suppressed further effectively.

In FIG. 3A and FIG. 3B, the tilt angles θa and θb of the first lens 15a and the second lens 15b are each set to be not greater than 26 degrees. Accordingly, as described above, the vibration amplitude of each secondary light source when the first lens 15a and the second lens 15b are vibrated can be ensured to be not less than 0.9 times the vibration amplitude in the case where the first lens 15a and the second lens 15b are not tilted. Therefore, suppression of speckles due to changes in the astigmatic differences of the secondary light sources can be effectively achieved while ensuring large vibration amplitudes of the secondary light sources and maintaining proper averaging of speckles.

As shown in FIG. 3A and FIG. 3B, the first lens 15a includes the plurality of first cylindrical lens portions 151a aligned in the direction perpendicular to the generatrices thereof, each of the plurality of first cylindrical lens portions 151a converges the laser beams in the first direction D1, the second lens 15b includes the plurality of second cylindrical lens portions 151b aligned in the direction perpendicular to the generatrices thereof, and each second cylindrical lens portion 151b converges the laser beams in the second direction D2. In addition, the plurality of first cylindrical lens portions 151a are aligned along the first vibration plane BPa, and the plurality of second cylindrical lens portions 151b are aligned along the second vibration plane BPb. The first vibrator 17a vibrates the first lens 15a in the direction (first vibration direction DBa) in which the plurality of first cylindrical lens portions 151a are aligned, and the second vibrator 17b vibrates the second lens 15b in the direction (second vibration direction DBb) in which the plurality of second cylindrical lens portions 151b are aligned.

Accordingly, a plurality of secondary light sources aligned in a matrix on the reference plane P0 can be formed by laser beams that have passed through each of the regions where the first cylindrical lens portions 151a and the second cylindrical lens portions 151b overlap, and the astigmatic difference of each secondary light source can be changed while each secondary light source is vibrated by vibration of the first lens 15a and vibration of the second lens 15b. Therefore, speckles that change due to the vibration of the first lens 15a and the second lens 15b are less likely to correlate with each other, so that speckles superimposed on a display image can be suppressed more effectively.

As shown in FIG. 1A and FIG. 1B, the field lens 16, which guides the laser beams that have passed through each of the regions where the first cylindrical lens portions 151a and the second cylindrical lens portions 151b overlap, to the entirety of the light modulation region R1 of the spatial light modulator 20, is included. Accordingly, even when the beam profiles of the laser beams emitted from the laser light sources 11a to 11c are non-uniform, illumination light (laser beam of each color) having a substantially uniform intensity distribution can be applied to the light modulation region R1 of the spatial light modulator 20. Therefore, it is possible to display a high-quality display image having no luminance unevenness.

<Modification 1>

In the above embodiment, both the first vibration plane BPa and the second vibration plane BPb are tilted with respect to the planes perpendicular to the optical axis OP. However, one of the first vibration plane BPa and the second vibration plane BPb may be tilted with respect to the plane perpendicular to the optical axis OP, and the other may be perpendicular to the optical axis OP.

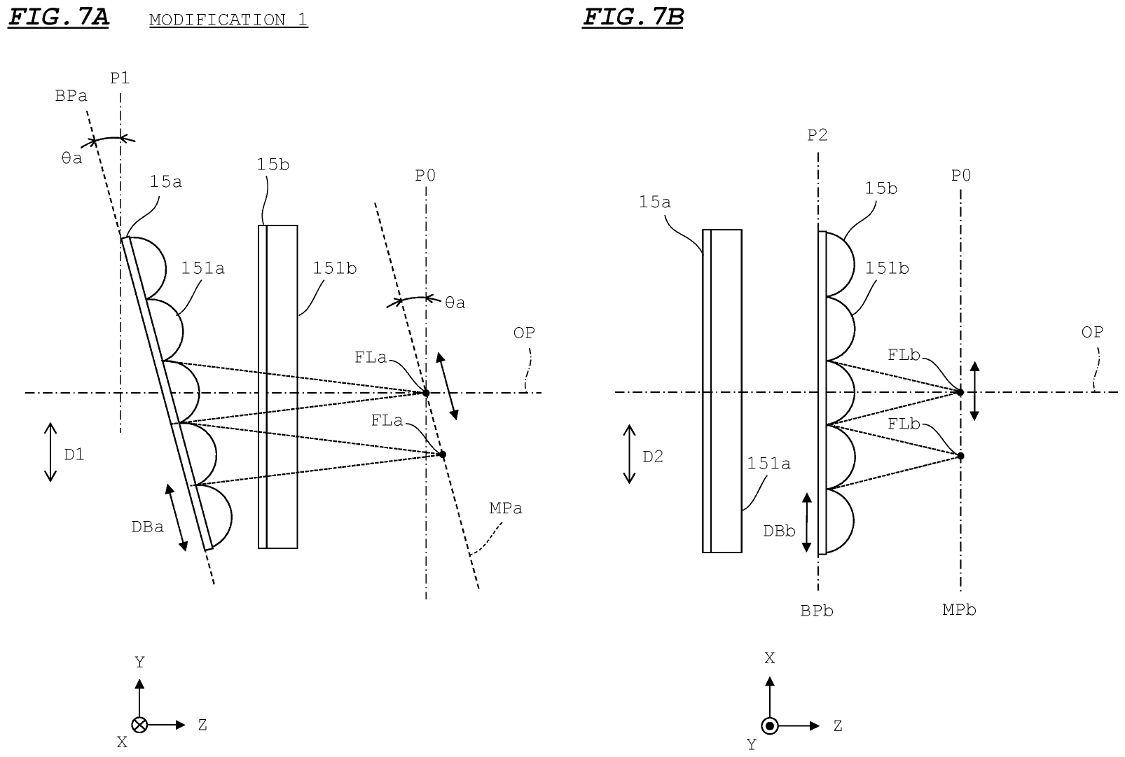

FIG. 7A and FIG. 7B illustrate a configuration in the case where, out of the first vibration plane BPa and the second vibration plane BPb, the first vibration plane BPa is tilted with respect to the plane P1 perpendicular to the optical axis OP, and the second vibration plane BPb is perpendicular to the optical axis OP.

As shown in FIG. 7A, the first lens 15a and the first vibration plane BPa are tilted at the tilt angle θa with respect to the plane P1 perpendicular to the optical axis OP, in the direction parallel to the Y-Z plane. In addition, the first lens 15a is vibrated in the first vibration direction DBa, whereby the first focal lines FLa formed by the first cylindrical lens portions 151a move parallel to the first vibration direction DBa, along the first movement plane MPa which is tilted at the tilt angle θa with respect to the optical axis OP.

On the other hand, as shown in FIG. 7B, the second lens 15b and the second vibration plane BPb are parallel to the plane P2 perpendicular to the optical axis OP. In addition, the second lens 15b is vibrated in the second vibration direction DBb parallel to the X axis, whereby the second focal lines FLb formed by the second cylindrical lens portions 151b move in the X-axis direction along the second movement plane MPb perpendicular to the optical axis OP.

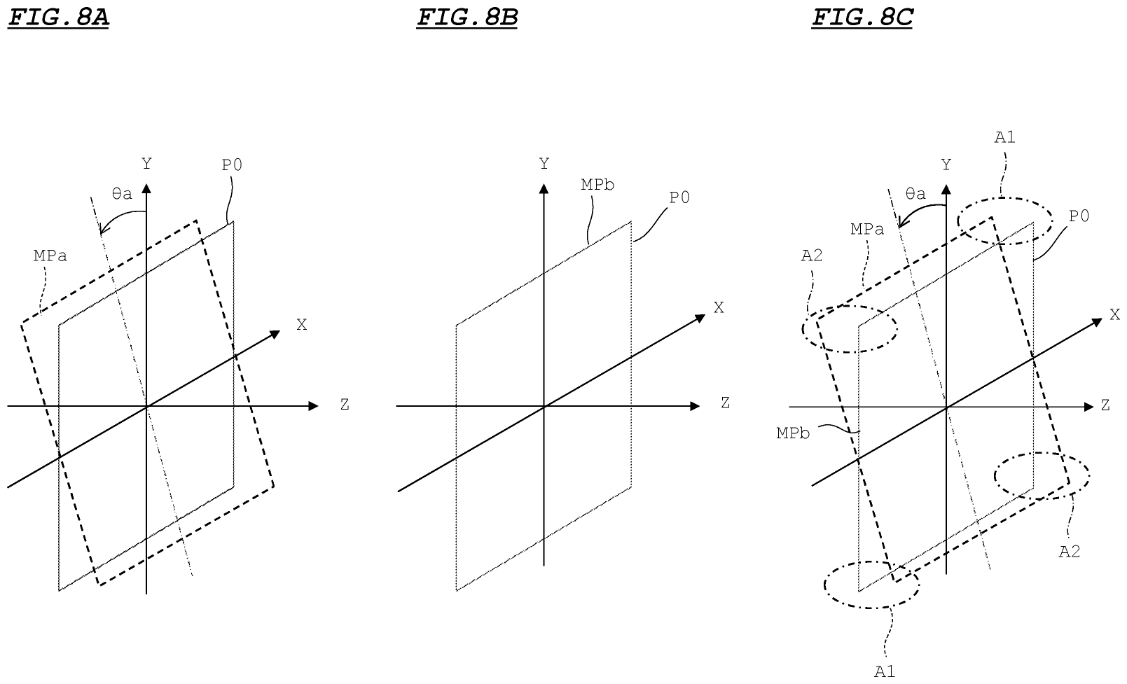

FIG. 8A is a perspective view showing the first movement plane MPa on which the first focal lines FLa move due to the vibration of the first lens 15a according to Modification 1, and FIG. 8B is a perspective view showing the second movement plane MPb on which the second focal lines FLb move due to the vibration of the second lens 15b according to Modification 1. FIG. 8C is a perspective view showing a state where the first movement plane MPa and the second movement plane MPb according to Modification 1 are integrated.

FIG. 8A is the same as FIG. 4A according to the above embodiment. On the other hand, in Modification 1, the second movement plane MPb for the second focal lines FLb formed by the second cylindrical lens portions 151b coincides with the reference plane P0, and is not tilted with respect to the plane perpendicular to the optical axis OP. In this case, the integration of the first movement plane MPa and the second movement plane MPb results in the state in FIG. 8C.

As shown in FIG. 8C, in the configuration of Modification 1 as well, when the secondary light sources move due to the vibration of the first lens 15a and the second lens 15b, the distance between the first focal line FLa and the second focal line FLb at each secondary light source changes along with the movement, so that the astigmatic difference of the secondary light source changes. Therefore, compared to the case where both the first lens 15a and the second lens 15b are vibrated perpendicularly to the optical axis OP (the case where the astigmatic difference does not change along with movement), speckles are more likely to be averaged by human eyes, so that the speckles become less noticeable on a display image.

In Modification 1, as shown in FIG. 8C, in the regions A1 or A2 at either opposite corner of the reference plane P0, the distance between the first movement plane MPa and the second movement plane MPb is the same. In addition, in FIG. 8C, compared to the case of FIG. 4C, the distance between the first movement plane MPa and the second movement plane MPb in the regions A2 is small. Therefore, in Modification 1, compared to the above embodiment, the amount of change in the astigmatic difference when each secondary light source moves due to the vibration of the first lens 15a and the second lens 15b is smaller. Therefore, from the viewpoint of further reducing the correlation between speckles by changes in the astigmatic differences of the secondary light sources, as in the above embodiment, it is preferable to tilt not only the first vibration plane BPa but also the second vibration plane BPb with respect to the plane perpendicular to the optical axis OP.

In FIG. 7A and FIG. 7B, out of the first vibration plane BPa and the second vibration plane BPb, only the first vibration plane BPa is tilted. However, out of the first vibration plane BPa and the second vibration plane BPb, only the second vibration plane BPb may be tilted. In this case as well, the same effects as those in FIG. 7A and FIG. 7B can be exhibited.

In the configuration of Modification 1 as well, the tilt angle θa is preferably set to be not greater than 26 degrees. Furthermore, in Modification 1 as well, as described with reference to FIG. 6A, the first frequency f1 at which the first lens 15a is vibrated and the second frequency f2 at which the second lens 15b is vibrated are preferably adjusted such that the movement trajectory of each secondary light source is as random as possible.

<Modification 2>

In the above embodiment, the first lens 15a and the second lens 15b are disposed so as to be tilted with respect to the planes perpendicular to the optical axis OP. However, the first lens 15a and the second lens 15b may be disposed perpendicularly to the optical axis OP, and only the first vibration plane BPa and the second vibration plane BPb may be set so as to be tilted with respect to the planes perpendicular to the optical axis OP.

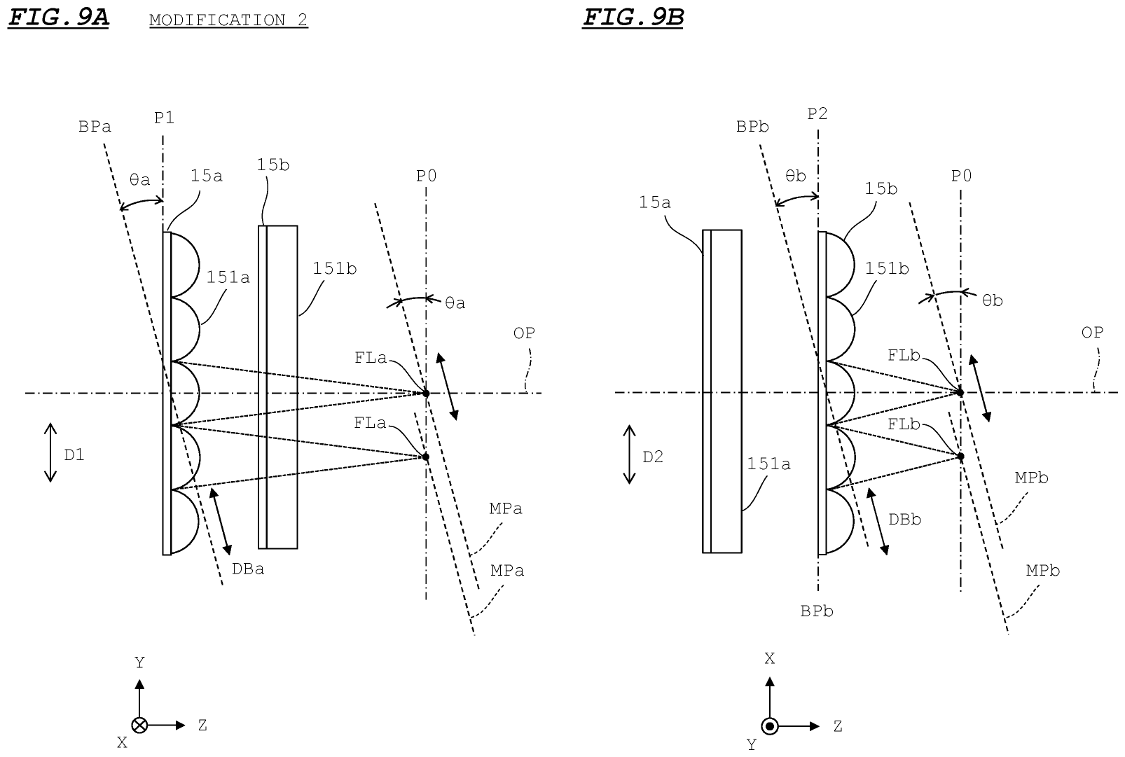

FIG. 9A and FIG. 9B illustrate a configuration in this case.

In the configuration of FIG. 9A and FIG. 9B as well, as in the above embodiment, secondary light sources are formed by the laser beams passing through each of the regions where the plurality of first cylindrical lens portions 151a and the plurality of second cylindrical lens portions 151b overlap. However, in Modification 2, unlike the above embodiment, each of the first focal lines FLa formed by the first cylindrical lens portions 151a is positioned on the reference plane P0, not on the common first movement plane MPa. Therefore, in Modification 2, along with the movement of the first lens 15a along the first vibration plane BPa, the respective first focal lines FLa move on first movement planes MPa different from each other. Similarly, in Modification 2, along with the movement of the second lens 15b along the second vibration plane BPb, the respective second focal lines FLb move on second movement planes MPb different from each other.

In the configuration of Modification 2 as well, since the plurality of first focal lines FLa and the plurality of second focal lines FLb move on the first movement planes MPa and the second movement planes MPb, respectively, along with the vibration of the first lens 15a and the second lens 15b, the astigmatic difference of each secondary light source changes along with the vibration of the first lens 15a and the second lens 15b. Therefore, even with the configuration of Modification 2, as in the above embodiment, averaging of speckles by the vibration of the secondary light sources and suppression of speckles by a change in the astigmatic difference of each secondary light source can be achieved. Therefore, speckles can be suppressed more effectively.

In the configuration of Modification 2 as well, as in the above embodiment, the tilt angles θa and θb are preferably set to be not greater than 26 degrees. Moreover, in Modification 2 as well, as described with reference to FIG. 6A, the first frequency f1 at which the first lens 15a is vibrated and the second frequency f2 at which the second lens 15b is vibrated are preferably adjusted such that the movement trajectory of each secondary light source is as random as possible. Furthermore, in the configuration of Modification 2 as well, as in Modification 1 above, only either one of the first vibration plane BPa and the second vibration plane BPb may be tilted with respect to the plane perpendicular to the optical axis OP.

<Other Modifications>

In the embodiment and Modifications 1 and 2 above, the first lens 15a is disposed on the laser light sources 11a to 11c side with respect to the second lens 15b. However, the second lens 15b may be disposed on the laser light sources 11a to 11c side with respect to the first lens 15a.

The configuration of each optical element included in the illumination device 10 is not limited to the configuration shown in the above embodiment, and can be changed as appropriate. For example, the configurations of the first lens 15a and the second lens 15b are not limited to the configurations in FIG. 2A and FIG. 2B, and the numbers of first cylindrical lens portions 151a and second cylindrical lens portions 151b can be changed as appropriate. Only one first cylindrical lens portion 151a may be disposed in the first lens 15a, or only one second cylindrical lens portion 151b may be disposed in the second lens 15b. The first lens and the second lens may be any lenses as long as the lenses can change the astigmatic difference of each secondary light source by vibration in vibration planes that are non-parallel to each other.

In the above embodiment, the three types of the laser light sources 11a, 11b, and 11c, which emit laser beams in the red, green, and blue wavelength bands, respectively, are used. However, in the case where a display image is a single-color image, only one type of laser light source that emits a laser beam in the wavelength band of this color may be disposed. For example, in the case where a display image is a single red color image, in the configuration of FIG. 1A and FIG. 1B, the laser light source 11a and the collimator lens 12a are left, and the laser light sources 11b and 11c, the collimator lenses 12b and 12c, and the dichroic mirrors 13 and 14 are omitted.

In the embodiment and Modifications 1 and 2 above, the illumination device 10 is provided in the image display device 1. However, the illumination device 10 may be used as an illumination light source of another device other than the image display device 1.

In addition to the above, various modifications can be made as appropriate to the embodiment of the present invention, without departing from the scope of the technological idea defined by the claims.

What is claimed is:

1. An image display device comprising:
a laser light source;
a first lens that converges a laser beam emitted from the laser light source, in a first direction;
a second lens that converges the laser beam emitted from the laser light source, in a second direction perpendicular to the first direction;
a spatial light modulator irradiated with the laser beam that has passed through the first lens and the second lens;
a first vibrator that vibrates the first lens along a first vibration plane; and
a second vibrator that vibrates the second lens along a second vibration plane non-parallel to the first vibration plane.

2. The image display device according to claim 1, wherein one of the first vibration plane and the second vibration plane is set to be perpendicular to an optical axis of the laser light source, and the other of the first vibration plane and the second vibration plane is set to be non-perpendicular to the optical axis.

3. The image display device according to claim 1, wherein both the first vibration plane and the second vibration plane are set to be non-perpendicular to an optical axis of the laser light source.

4. The image display device according to claim 2, wherein a tilt angle of a vibration plane non-perpendicular to the optical axis, out of the first vibration plane and the second vibration plane, with respect to a plane perpendicular to the optical axis, is set to be not greater than 26 degrees.

5. The image display device according to claim 1, wherein
the first lens includes a plurality of first cylindrical lens portions aligned in a direction perpendicular to generatrices thereof, and the plurality of first cylindrical lens portions each converge the laser beam in the first direction, and
the second lens includes a plurality of second cylindrical lens portions aligned in a direction perpendicular to generatrices thereof, and the plurality of second cylindrical lens portions each converge the laser beam in the second direction.

6. The image display device according to claim 5, wherein
the plurality of first cylindrical lens portions are aligned along the first vibration plane, and
the plurality of second cylindrical lens portions are aligned along the second vibration plane.

7. The image display device according to claim 6, wherein
the first vibrator vibrates the first lens in the direction in which the plurality of first cylindrical lens portions are aligned, and
the second vibrator vibrates the second lens in the direction in which the plurality of second cylindrical lens portions are aligned.

8. The image display device according to claim 5, further comprising a field lens that guides the laser beam that has passed through each of regions where the first cylindrical lens portions and the second cylindrical lens portions overlap, to an entirety of a light modulation region of the spatial light modulator.

9. The image display device according to claim 1, further comprising a drive circuit that drives the first vibrator and the second vibrator, wherein
the drive circuit makes a drive frequency of the first vibrator and a drive frequency of the second vibrator different from each other.

10. An illumination device comprising:
a laser light source;
a first lens that converges a laser beam emitted from the laser light source, in a first direction;
a second lens that converges the laser beam emitted from the laser light source, in a second direction perpendicular to the first direction;
a first vibrator that vibrates the first lens along a first vibration plane; and
a second vibrator that vibrates the second lens along a second vibration plane non-parallel to the first vibration plane.

11. The illumination device according to claim 10, wherein one of the first vibration plane and the second vibration plane is set to be perpendicular to an optical axis of the laser light source, and the other of the first vibration plane and the second vibration plane is set to be non-perpendicular to the optical axis.

12. The illumination device according to claim 10, wherein both the first vibration plane and the second vibration plane are set to be non-perpendicular to an optical axis of the laser light source.

13. The illumination device according to claim 11, wherein a tilt angle of a vibration plane non-perpendicular to the optical axis, out of the first vibration plane and the second vibration plane, with respect to a plane perpendicular to the optical axis, is set to be not greater than 26 degrees.

14. The illumination device according to claim 10, wherein
the first lens includes a plurality of first cylindrical lens portions aligned in the first direction, and the plurality of first cylindrical lens portions each converge the laser beam in the first direction, and
the second lens includes a plurality of second cylindrical lens portions aligned in the second direction, and the plurality of second cylindrical lens portions each converge the laser beam in the second direction.

15. The illumination device according to claim 14, wherein
the first lens is disposed such that the plurality of first cylindrical lens portions are aligned along the first vibration plane, and
the second lens is disposed such that the plurality of second cylindrical lens portions are aligned along the second vibration plane.

16. The illumination device according to claim 15, wherein
the first vibrator vibrates the first lens in the first direction, and
the second vibrator vibrates the second lens in the second direction.

17. The illumination device according to claim 14, further comprising a field lens that guides the laser beam that has passed through each of regions where the first cylindrical lens portions and the second cylindrical lens portions overlap, to an entirety of an illumination region.
